(19) United States
(12) Patent Application Publication
(10) Pub. No.: US 2015/0072424 A1
(43) Pub. Date: Mar. 12, 2015

(54) CRYOGENIC COOLING THIN FILM EVAPORATOR

(71) Applicants: HONGBIN MA, Columbia, MO (US); Fengmin Su, Dalian (CN); Xu Han, Columbia, MO (US); Hsiu-Hung Chen, Columbia, MO (US)

(72) Inventors: HONGBIN MA, Columbia, MO (US); Fengmin Su, Dalian (CN); Xu Han, Columbia, MO (US); Hsiu-Hung Chen, Columbia, MO (US)

(21) Appl. No.: 14/482,692

(22) Filed: Sep. 10, 2014

Related U.S. Application Data
(60) Provisional application No. 61/960,111, filed on Sep. 10, 2013.

(51) Int. Cl. F25D 7/00; A01N 1/02

(52) U.S. Cl. CPC F25D 7/00; A01N 1/0284
USPC 435/374; 62/304; 62/121

(57) ABSTRACT

One aspect of the present invention is directed to an apparatus for cryogenically cooling a substance. The apparatus of the present invention includes a thin film evaporator comprising a microstructured surface and an applicator for dispensing a working fluid onto the microstructured surface. The apparatus preferably contains a pressure-controlled vessel enclosing the thin film evaporator and at least a portion of the applicator. In a second aspect, the present invention is directed to the method of using a thin film evaporator of the present invention to cryogenically cool a substance by forming a thin film layer of the working fluid on the microstructured surface of the thin film evaporator.

### CROSS-REFERENCE TO RELATED APPLICATIONS

This application is based on and claims priority to U.S. Provisional Application Ser. No. 61/960,111 filed on Sep. 10, 2013, which is incorporated herein by reference in its entirety.

### STATEMENT REGARDING FEDERALLY SPONSORED RESEARCH OR DEVELOPMENT

This invention was made with Government support under Grant No.1 R21 RR025908-02 awarded by the National Institutes of Health. The Government has certain rights in the invention.

### BACKGROUND OF THE INVENTION

1. Field of the Invention

The present invention relates in general to both a cryogenic cooling thin film evaporator and a method for using same.

2. Description of Related Art

Cryogenic cooling is used in a variety of applications, including but not limited to cell and embryo cryopreservation, cryosurgery, cryoelectronics and cryotronics, cryobiology, cryofixation and cryosubstitution for electron microscopy, and cryogenics.

One prevalent method of cell cryopreservation is vitrification, a method which is regarded as a preferred alternative to the traditional slow freezing method. Vitrification, a process in which both cells and extracellular solutions are solidified without ice formation, is typically achieved by a “pool boiling” procedure. In a “pool boiling” procedure, samples are directly plunged or dropped into a pool of coolant that is typically liquid nitrogen. Cells generally are not in direct contact with liquid nitrogen; rather, they are either surrounded by solutions or some layers of polymers, thus forming a “sample.” Vitrification offers two advantages over the traditional slow freezing method. First, vitrification causes the cell temperature to drop more rapidly through the temperature range where intracellular and extracellular ice crystals can form than the traditional slow freezing method, resulting in reduced cell mechanical injury (or avoiding cell injury altogether). Second, vitrification methods eliminate the need for the time consuming and laborious cooling procedures involved in slow cooling methods.

In a conventional vitrification procedure using pooling boiling cooling methods, the typical cooling rate of cells is approximately 2,500° C./min. The use of an electron microscope (EM) grip in a pool boiling method can increase the cooling rate to 24,000° C./min. The use of open pulled straws (OPS) in a pool boiling method can increase the cooling rate to 20,000° C./min. Likewise, the use of a cryoloop in a pool boiling method can increase the cooling rate to 20,000° C./min. Although these methods achieve complete or partial vitrification of cell suspensions, highly concentrated cryoprotectants are required, resulting in reduced cell survival rates due to the toxicity of the cryoprotectant.

The primary reason to date that the cooling rate for vitrification methods has not been increased and there is a dependence on the use of higher concentrations of cryoprotectants is that liquid nitrogen vaporizes near the surface of the samples while the samples are submerged in the liquid nitrogen. The evaporating nitrogen forms a heat insulating layer referred to as a “vapor blanket.” As a result, the heat transfer coefficient between the sample surface and the liquid nitrogen is limited (less than 10³ W/m²K) due to the poor thermal conduction of the “vapor blanket.” Therefore, removal of the “vapor blanket” is critical in order to further improve upon the cooling rate of conventional vitrification.

### BRIEF SUMMARY OF THE INVENTION

The present invention is directed in a first aspect to an apparatus for the cryogenic cooling of a substance. The apparatus includes a microstructured surface and an applicator for dispensing a working fluid onto the microstructured surface. In one aspect of the invention, the microstructured surface includes micropores. The micropores may have a diameter between 1 and 100 microns in diameter. The micropores may be formed from microparticles, which may have a diameter between 1 and 500 microns. In another aspect of the invention, the microstructured surface may be formed from microstructures such as nanowires, etched microchannels and microfabricated microstructures. In one aspect of the invention, the microstructured surface may be made of a metal selected from the group consisting of copper, gold, silver, iron, aluminum, nickel, platinum, and their oxides. In one aspect of the invention, the total thickness of the microstructured surface may range from 1 to 1000 microns.

In one aspect of the invention, the microstructured surface may include a base that supports the microstructured surface. In one such aspect, the base may have a thickness ranging from 10 to 1000 microns. In one such aspect, the base may be formed from a metal selected from the group consisting of copper, gold, silver, iron, aluminum, nickel, platinum, and their oxides. In one aspect, the base is formed from the same metal as the microstructured surface.

In one aspect of the invention, the apparatus may also include a pressure-controlled vessel that encloses the thin film evaporator and at least a portion of said applicator. In one such aspect, the pressure of the pressure-controlled vessel is controlled by a vacuum operably connected to the vessel.

In another aspect of the invention, the present invention is directed to a method for using an apparatus of the present invention. In one such embodiment, the apparatus comprises a thin film evaporator having a first microporous surface and a second surface opposite the microporous surface. In one such aspect, a substance to be cooled is placed adjacent to the second surface. In one such aspect, a working fluid is then dispensed onto the microstructured surface such that the working fluid forms a thin liquid film. In one aspect, the working fluid may be liquid nitrogen, liquid helium, liquid oxygen, or liquid oxygen. In one aspect, the thickness of the thin liquid film formed is between 1 and 100 microns. In one aspect of the present invention, the pressure of the thin film evaporator is lowered from a first pressure to a second pressure that is below the saturation pressure of the working fluid prior to dispensing the working fluid onto the microstructured surface. In one such aspect, the pressure lowering step may be performed by a vacuum.

In one embodiment, the method of the second aspect of the present invention is performed such that the thin film evaporator is enclosed in a pressure-controlled vessel during the pressure lowering step wherein the pressure of the thin film evaporator is lowered from a first pressure to a second pressure. In one such aspect, the pressure of the pressure-controlled vessel may be maintained at the second pressure of the thin film evaporator below the saturation pressure of the working fluid while the working fluid is being dispensed onto the microstructured surface.

In one aspect of the invention, the method of the present invention may be used to cool substances including but not limited to living cells, living embryos, or living thin tissues.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1(a-1) depicts a cross-sectional view of one exemplary embodiment of the thin film evaporator of the present invention.

FIG. 1(a-2) depicts a top-plan view of one exemplary embodiment of the thin film evaporator of the present invention.

FIG. 1(b) depicts a 3D photograph of an exemplary microstructured surface of one embodiment of the present invention, produced in Example 1.

FIG. 1(c) is a horizontal cross-sectional view of an exemplary microstructured surface of one embodiment of the present invention, produced in Example 1.

FIG. 2 depicts a schematic of one exemplary embodiment of the apparatus of the present invention.

FIG. 3 is a chart demonstrating the pressure variation over time as recorded in the pressure-controlled vessel during Experiment 1.

FIG. 4 is a chart comparing the temperature change in Experiment 1 with the temperature change in Experiment 2.

### DETAILED DESCRIPTION OF PREFERRED EMBODIMENT

One aspect of the present invention is directed to an apparatus for cryogenically cooling a substance. The apparatus of the present invention includes a thin film evaporator comprising a microstructured surface and an applicator for dispensing a working fluid onto the microstructured surface. The apparatus preferably contains a pressure-controlled vessel enclosing the thin film evaporator and at least a portion of the applicator. In a second aspect, the present invention is directed to the method of using a thin film evaporator of the present invention to cryogenically cool a substance by forming a thin film layer of the working fluid on the microstructured surface of the thin film evaporator.

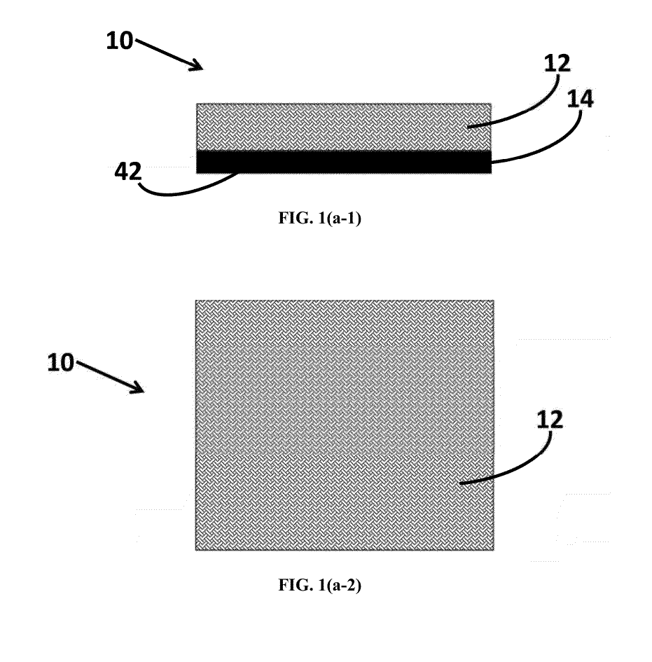

Looking to FIG. 1(a), in one embodiment of the present invention, the apparatus of the present invention comprises a thin film evaporator 10. Thin film evaporator 10 comprises a microstructured surface 12 and optionally a base 14 supporting the microstructured surface 12. In one embodiment, base 14 and microstructured surface 12 are generally planar. Turning to FIG. 1(b), a photograph of microstructured surface 12 obtained using an Olympus laser scanning confocal microscope is shown. Microstructured surface 12 defines a plurality of micropores 16. Micropores 16 are of a size that allows the working fluid to be drawn into the micropores through capillary action. Micropores 16 are preferably between 1 and 1000 microns in diameter and in one embodiment are between 1 and 100 microns in diameter.

Microstructured surface 12 may be comprised of any structures that form pores consistent with the present invention. Structures forming the microstructured surface 12 may include microparticles, nanowires, etched microchannels, and microfabricated microstructures.

In the embodiment wherein microstructured surface 12 is comprised of microparticles, as depicted in FIGS. 1(b) and 1(c). (FIG. 1(c) was taken with a Micro-CT by Xradia, Inc.), the microparticles are preferably between 1 and 500 microns in diameter and in one such embodiment are between 10 and 200 microns in diameter. The size of the microparticles will vary depending on the application and use. Microstructured surface 12 may comprise one or more layers of microparticles. The microparticles may be formed into the microstructured layer by sintering. Suitable sintering processes are well known to those of ordinary skill in the art. In the embodiment wherein base 14 is present, the microparticles may be sintered onto a surface of base 14.

Micro structured surface 12 may be comprised of any material suitable for forming microstructures consist with the present invention. In one embodiment, the microstructured surface is formed from a metal, preferably a metal that may be sintered, formed into nanowires, etched or microfabricated microstructures. The metal may be selected from the group consisting of copper, gold, silver, iron, aluminum, nickel, and platinum. Copper, gold, and silver are particularly well-suited for use in the present invention. In one embodiment, the microstructured surface is formed from a metal oxide, preferably a metal oxide that may be sintered, formed into nanowires, etched or microfabricated microstructures. The metal oxide may be selected from the group consisting of copper oxide, gold oxide, silver oxide, iron oxide, aluminum oxide, nickel oxide, and platinum oxide.

In one embodiment of the invention, microstructured surface 12 is between 1 and 1000 microns thick, and in one such embodiment is between 10 and 200 microns thick. In one exemplary embodiment, the microstructured surface is 150 microns thick. The thickness of microstructured surface 12 will vary depending on the specific application and use.

Base 14 of thin film evaporator 10, if present, may be formed of any material described above with respect to microstructured surface 12. Base 14 and microstructured surface 12 may be comprised of the same material or different materials. Base 14 may be any thickness capable of supporting microstructured surface 12. In one embodiment, base 14 is thinner than microstructured surface 12. In one such embodiment base 14 is between 10 and 1000 microns thick, or between 100 and 200 microns thick. In one exemplary embodiment, base 14 is 50 microns thick. In one embodiment, the total thickness of thin film evaporator 10, including both microstructured surface 12 and base 14 is between 10 and 1000 microns thick, or between 100 and 500 microns thick.

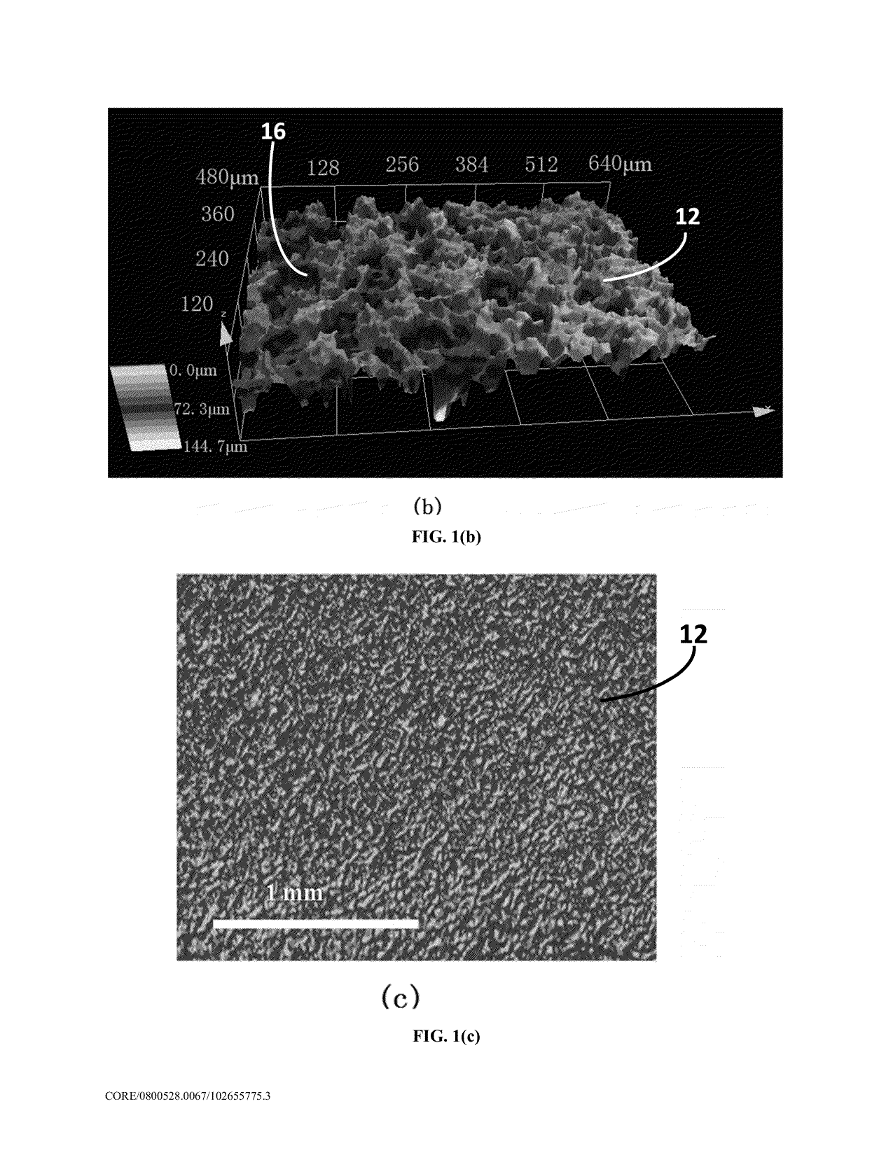

Although the thin film evaporator is generally planar in the exemplary embodiment depicted in FIG. 2, thin film evaporators of a variety of configurations are nonetheless within the scope of the present invention. In one embodiment, the thin film evaporator is a sheet form. In such an embodiment, the thin film evaporator sheet that may be curved, corrugated, or another configuration that permits application of the substance.

The shape and dimension of the thin film evaporator may vary depending on the substance to be cryogenically cooled. In certain embodiments the thin film evaporator will be a rectangular, square or rounded shape but is not limited to such shapes.

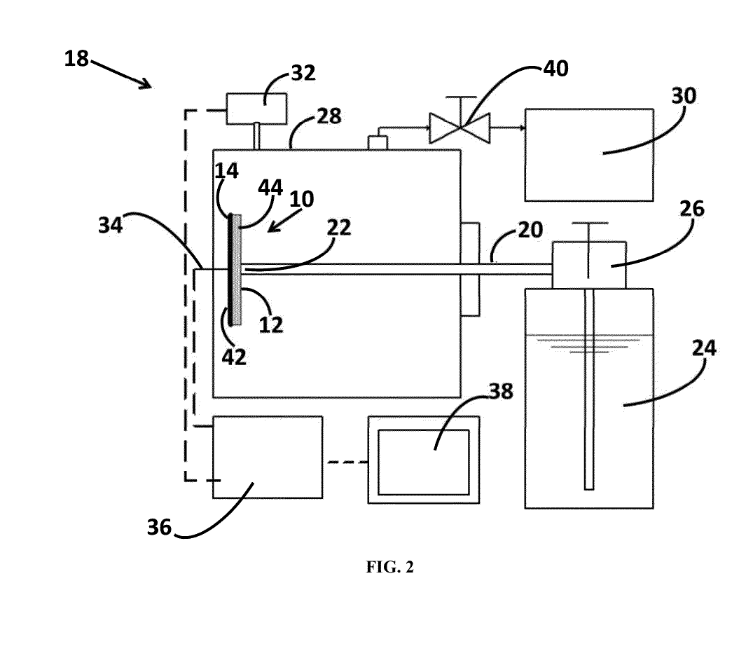

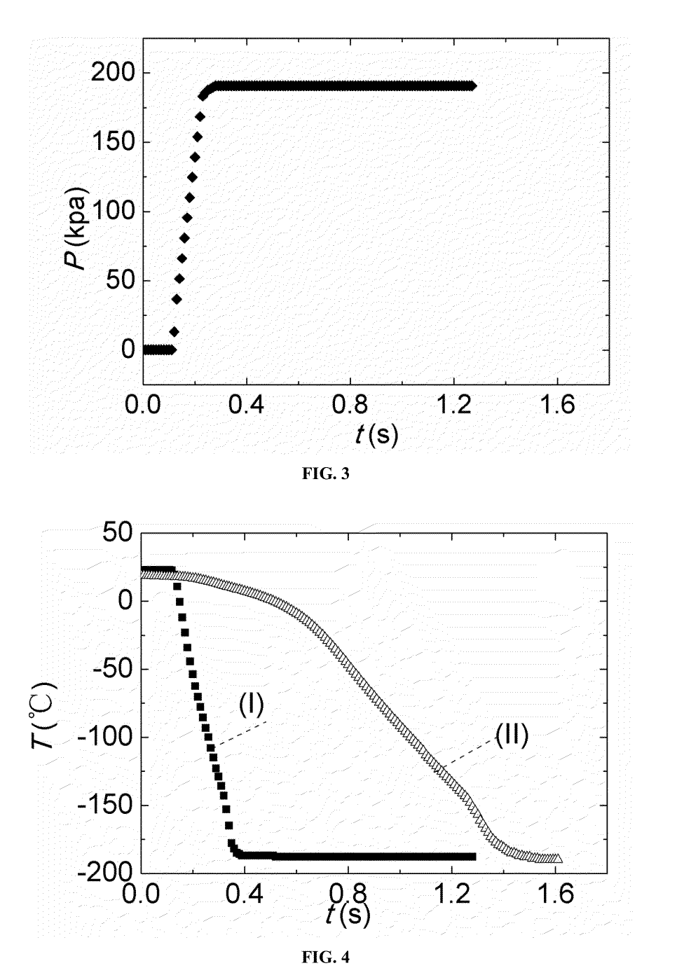

FIG. 2 shows one exemplary embodiment of apparatus 18 of the present invention. Apparatus 18 comprises an applicator 20 for dispensing a working fluid onto microstructured surface 12 of thin film evaporator 10. As used herein, dispensing “onto” the microstructured surface means dispensing the working fluid to make contact with the microstructured surface. “Onto” does not require that the working fluid be dispensed on top of the microstructure surface. Applicator may be any device capable of dispensing a working fluid into contact with microstructured surface 12, such as a needle, an array, or a nozzle. Applicator 20 comprises an outlet 22 through which the working fluid is dispensed. Outlet 22 is located proximate to microstructured surface 12 so that the working fluid dispensed from applicator 20 through outlet 22 comes into contact with microstructured surface 12. In the embodiment depicted in FIG. 3, applicator 20 extends generally horizontally such that outlet 22 abuts microstructured surface 12, although any other configuration that allows the working fluid to be dispensed into contact with microstructured surface 12 can be employed consistent with the present invention. Applicator 20 may be directly connected to a container 24 containing a working fluid or a line may be run from applicator 20 to container 24. Container 24 preferably comprises a valve 26 or other device for regulating flow of the working fluid out of a container 24 through applicator 20.

In the exemplary embodiment shown in FIG. 2, thin film evaporator 10 is contained within a pressure-controlled vessel 28. Pressure-controlled vessel 28 encloses thin film evaporator 10 and at least the outlet 22 portion of applicator 20. Thin film evaporator 10 is depicted as extending along a generally vertical plane, although other spatial-orientations may be used consistent with the present invention. Apparatus 18 preferably comprises a vacuum pump 30 operably connected to pressure-controlled vessel 28. The pressure of pressure-controlled vessel 28 may be controlled by vacuum pump 30 or any other type of pressure regulator that is operably connected to the pressure-controlled vessel 28.

Pressure-controlled vessel 28 may have a pressure sensor or pressure gauge 32 operably connected to it that is used to monitor and measure the pressure within pressure-controlled vessel 28. A thermocouple 34 may also be attached to the back of thin film evaporator 10 (i.e., the side opposite microstructured surface 12 which is referred to as second surface 42 below) to monitor and measure its temperature over time. A data acquisition (“DAQ”) system 36 connected to a computer 38 may also be connected to pressure sensor 32 and thermocouple 34 to record the temperature and pressure. DAQ 36 and computer 38 may also be operably connected to valve 26 and/or a vacuum valve 40 to regulate the vacuum and liquid flow applied to pressure-controlled vessel 28. In a commercial setting, DAQ 36, computer 38, pressure sensor 32, and thermocouple 34 may be entirely omitted.

The present invention is also directed to a method for using the thin film evaporator of the present invention. In one such embodiment, a thin film evaporator according to the present invention is provided. Thin firm evaporator 10 comprises a first microstructured surface 12 and a second surface 42 opposite the first micro structured surface. Second surface 42 may be a surface of microstructured surface 10 opposite a first surface of microstructured surface 10. Alternatively, if base 14 is included, second surface 42 is the surface of base 14 opposite microstructured surface 12. A substance to be cryogenically cooled is placed adjacent to second surface 42. As used herein, “adjacent” includes direct application of the substance to second surface 42, as well as placement of the substance sufficiently near second surface 42 to come into contact with the thin liquid film (as described below). Preferably the substance is placed within 1 to 100 microns of second surface 42. In one embodiment, the substance is applied adjacent to second surface 42 such that it is of uniform thickness so that the cooling of the substance occurs as uniformly and evenly as possible.

A working fluid is then dispensed to contact microstructured surface 12 such that the working fluid forms a thin liquid film 44 along at least a portion of microstructured surface 12. The working fluid will preferably spread along the entire surface of microstructured surface 12, and into micropores 16, due to the capillary force produced by the microstructured surface. Microstructured surface 12 produces capillary force and disjoining pressure to form the thin liquid film on the microstructured surface. This in turn prevents the microstructured surface from drying out. Importantly, it also reduces the formation of a vapor blanket which allows an ultra-fast cooling rate to be achieved. In one embodiment the thin liquid film is between 1 and 100 microns thick, and in one such embodiment between 1 and 10 microns thick.

The presence of the numerous microscale pores in microstructured surface 12 increases the surface area over that which would be offered by a smooth, flat surface, thereby increasing the total evaporating thin film region. Additionally, the thermal resistance across the thin liquid film is very small because the evaporating thin film is very thin, resulting in an increased heat transfer coefficient. The increased heat transfer coefficient causes the evaporating surface temperature to fall rapidly from room temperature to the saturation temperature. In one embodiment, the heat transfer coefficient between the sample surface and the thin film is at least 10⁷W/m²K, and in one such embodiment at least 10⁵W/m²K.

The time required to fall from a first starting temperature to a second cooling temperature can be less than 0.1 seconds and in one such embodiment is between 0.2 and 0.3 seconds. The second cooling temperature can be readily determined based on the intended use of the apparatus and process of the invention. In one embodiment, wherein the apparatus is used for cryopreservation, the second temperature is lower than −190° C., and in one such embodiment between −196° C. and −190° C. The average cooling rate can exceed 10⁵ ° C./minute and in one embodiment is between 10⁴ and 10⁵° C./minute. In such an embodiment, the average cooling rate was observed to be more than three times higher than the cooling rate observed using standard vitrification techniques.

The working fluid may be any liquid that vaporizes at cryogenic temperatures. The working fluid may be but is not limited to liquid helium, liquid nitrogen, liquid oxygen, liquid argon, and many others. The working fluid is applied at a mass flow rate sufficient to keep maintain a thin film of liquid working fluid on the microstructured surface. The vacuum pump or other pressure regulator will affect the required mass flow rate, as will be readily understood by one of ordinary skill in the art. In one exemplary embodiment, the mass flow rate of liquid nitrogen as the working gas is 1.934 g/s.

In one embodiment, the pressure surrounding the thin film evaporator is lowered from a first pressure to a second pressure below the saturation pressure of the working fluid, preferably prior to the dispensing step. When the thin film evaporator is at room temperature, the relevant saturation pressure is the saturation pressure at room temperature. Ideally, the pressure of the pressure-controlled vessel is maintained such that the vessel is as close to a pure vacuum as possible. In one exemplary embodiment where nitrogen is the working fluid, the pressure may be lowered to 500 Pa. A vacuum pump is preferably used to lower the pressure, although other pressure regulators may be used. In the embodiment wherein the thin film evaporator is enclosed within a pressure-controlled vessel, the pressure of the vessel is lowered so that it is lower than the saturation pressure of the working fluid. The second pressure within the vessel is preferably maintained below the saturation pressure of the working fluid during the dispensing step. In the exemplary embodiment shown in FIG. 2, vacuum pump 30 is used to lower the pressure in pressure-controlled vessel 28 from the first pressure to the second pressure below the saturation pressure of the working fluid.

The working fluid is then dispensed onto microstructured surface 12 via an applicator as discussed above. The further below the saturation pressure at room temperature of the working fluid that the pressure of the vessel is maintained, the higher the rate of evaporation of the working fluid will be and the faster that molecules of the working fluid that are in the vapor phase will move away from the liquid-vapor interface of the working fluid and toward the vapor within the vessel. This in turn causes the temperature at the liquid-vapor interface to decrease at a faster rate.

The method of the present invention may be used to cryogenically cool substances including but not limited to living cells, living embryos, and living thin tissues. The method of the present invention may be used in various applications in which cryogenic cooling is desirable. In addition the cryopreservation of biological tissue discussed herein, other applications include cryosurgery, cryofixing in electron microscopy, cryogenic thermal management that can be used in spacecraft or other environments, and cryogenic machining.

The following examples are directed to various exemplary embodiments of the apparatus and method of the present invention and their use in accordance with the present invention.

### Example 1

A pressure-controlled vessel was connected to a vacuum pump to control the pressure and to enhance the evaporation of liquid nitrogen. The generally planar thin film evaporator with a microstructured surface is depicted in FIG. 1. Its measurements were 5 mm×5 mm×0.05 mm, it was formed from copper, and its microstructured surface was formed of several layers copper microparticles (50 μm in diameter, Goodfellow Cambridge Ltd.). The thickness of the microstructured surface was 150 The copper microparticles were applied to the generally planar thin film evaporator base utilizing a sintering process well known to persons of ordinary skill in the art. The generally planar thin film evaporator was then placed inside the pressure-controlled vessel so that it extended generally within a vertical plane. An Omega thermocouple with a diameter of 0.5 mm was attached on the back of the generally planar thin film evaporator in order to monitor its temperature during the cooling process. The working fluid utilized was liquid nitrogen, which was stored in a container (CRY-Ac® B-700, manufactured by Brymill Cryogenic Systems). The container was connected with a line that ran to a needle (2 mm inner diameter, 291 mm length) that served as the applicator to apply the liquid nitrogen to the micro structured surface of the generally planar thin film evaporator. The end of the needle was placed horizontally against the microstructured surface of the generally thin film evaporator. A pressure sensor was used to measure the pressure of the vessel. A DAQ (NI SCXI-1000) was connected with a personal computer and used to record the temperature and pressure. The sampling rate of the DAQ was set at 10,000 samples or measurements per second.

Prior to the start of the experiment, the pressure of the pressure-controlled vessel was brought to an absolute pressure of approximately 500 Pa. The valve on the liquid nitrogen container was then opened. Liquid nitrogen flowed from the liquid nitrogen container and through the needle to the generally planar thin film evaporator. As liquid nitrogen reached the point of application of the microstructured surface, the liquid spread along the remainder of the microstructured surface due to the capillary force produced by the microscale pores of the microstructures shown in FIGS. 1(b) and 1(c). Because the pressure of the pressure-controlled vessel was significantly lower than the saturation pressure of nitrogen at room temperature, the molecules of nitrogen at the liquid-vapor interface moved away from the liquid-vapor interface at a faster rate. This high rate of mass transfer of nitrogen caused the temperature at the liquid-vapor interface to rapidly decrease. Because the evaporating thin film had a thickness of approximately 100 microns, the thermal resistance across the thin liquid film was very small. This resulted in a higher heat transfer coefficient. The increased heat transfer coefficient in turn caused the temperature of the generally planar thin film evaporator to fall sharply from room temperature to the saturation temperature of nitrogen.

The vacuum pump was continually operated during the experiment and removed some of the nitrogen vapor within the pressure-controlled vessel. The pressure within the pressure-controlled vessel rose from approximately 500 Pa to approximately 190,670 Pa as shown in FIG. 5. This rise in pressure was attributable to the nitrogen vapor added to the pressure-controlled vessel that was not removed by the vacuum pump (i.e., the amount of nitrogen exiting the pressure-controlled vessel via the vacuum pump was lower than the amount of liquid nitrogen evaporating within the pressure-controlled vessel). The saturation temperature of liquid nitrogen at the pressure of the pressure-controlled vessel at 190,670 Pa is −188° C., which, as shown in FIG. 6, was the approximate temperature of the generally planar thin film evaporator as measured at the end of the experiment. To calculate the approximate mass flow rate of liquid nitrogen used during the experiment, the total mass of the pressure-controlled vessel was measured before and after the experiment, respectively. The difference between the two measurements was hence the approximate mass of liquid nitrogen used in the experiment. This number was then divided by the running time of the experiment. In this way, the approximate mass flow rate of liquid nitrogen was calculated to be 1.934 g/s. It should be noted that any nitrogen that was removed from the pressure-controlled vessel during the experiment by the vacuum pump would not have been accounted for in the calculation of the flow rate of the nitrogen given that the cooling process is so short and any amount removed would be negligible.

### Example 2

In order to compare the cryogenic cooling performance of the generally planar thin film evaporator as used in Experiment 1 (thin film evaporation) with a pool boiling process, a comparative experiment in which the generally planar thin film evaporator was plunged directly into liquid nitrogen was also performed. FIG. 6 shows the temperature histories of both Experiment 1 (thin film evaporation) and Experiment 2 (pool boiling). As shown in FIG. 6, the cooling rate observed utilizing thin film evaporation was higher than that observed with pool boiling. It took only 0.241 seconds for the temperature of the generally planar thin film evaporator to drop from 10° C. to −187° C. via the thin film evaporation technique performed during Experiment 1. The average cooling rate of Experiment 1 was thus 49,045° C./min. By comparison, it took 1.11 seconds for the temperature of the generally planar thin film evaporator to drop from 10° C. to −187° C. via the pool boiling technique performed during Experiment 2. The average cooling rate observed during Experiment 2 was thus 10,639° C./min. It therefore follows that the cooling rate observed utilizing thin film evaporation was 3.6 times higher than that observed utilizing pool boiling. The average cooling rate observed utilizing thin film evaporation was more than two times higher than the average cooling rates observed in performing the open pulled straws (OPS) and electron microscopy EM grid methods, both of which have cooling rates that are approximately 20,000-24,000° C./min.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. An apparatus for the cryogenic cooling of a substance comprising:
a thin film evaporator comprising a microstructured surface; and
an applicator for dispensing a working fluid onto said microstructured surface.

2. The apparatus of claim 1, wherein said microstructured surface comprises micropores having a diameter between 1 and 100 microns in diameter.

3. The apparatus of claim 1, wherein said microstructured surface is comprised of one or more layers of microparticles.

4. The apparatus of claim 3, wherein said microparticles are between 1 and 500 microns in diameter.

5. The apparatus of claim 1, wherein said microstructured surface is comprised microstructures selected from the group consisting of nanowires, etched microchannels and microfabricated microstructures.

6. The apparatus of claim 1, wherein said microstructured surface is comprised of a metal selected from the group consisting of copper, gold, silver, iron, aluminum, nickel, palladium, and their oxides.

7. The apparatus of claim 1, wherein said microstructured surface has a thickness between 1 and 1000 microns.

8. The apparatus of claim 1, wherein said thin film evaporator further comprises a base supporting said microstructured surface.

9. The apparatus of claim 8, wherein said base has a thickness between 10 and 1000 microns.

10. The apparatus of claim 8, wherein said base is comprised of a metal selected from the group consisting of copper, gold, silver, iron, aluminum, nickel, platinum, and their oxides.

11. The apparatus of claim 8, wherein said base and said microstructured surface are comprised of the same material.

12. The apparatus of claim 1, wherein said apparatus further comprises a pressure-controlled vessel that encloses said thin film evaporator and at least a portion of said applicator.

13. The apparatus of claim 12, wherein said pressure-controlled vessel is operably connected to a vacuum.

14. The apparatus of claim 1, wherein said thin film evaporator is a sheet.

15. A method for the cryogenic cooling of a substance comprising the steps of:
a. providing a thin film evaporator comprising a first microstructured surface and a second surface opposite said microstructured surface at a first pressure;
b. placing the substance adjacent to said second surface;
c. dispensing a working fluid onto said microstructured surface such that the working fluid forms a thin liquid film.

16. The method of claim 15, wherein the microstructured surface is comprised of a metal selected from the group consisting of copper, gold, silver, iron, aluminum, nickel, platinum, and their oxides.

17. The method of claim 15, wherein said microstructured surface is comprised of one or more layers of microparticles.

18. The method of claim 17, wherein said microparticles are between 1 and 500 microns in diameter.

19. The method of claim 15, wherein the thickness of said microstructured surface is between 1 and 1000 microns.

20. The method of claim 15, wherein said working fluid is selected from the group consisting of liquid nitrogen, liquid helium, liquid oxygen, and liquid argon.

21. The method of claim 15, wherein the thickness of said thin liquid film is between 1 and 100 microns.

22. The method of claim 15, further comprising lowering the first pressure of said thin film evaporator to a second pressure below a saturation pressure of the working fluid prior to said dispensing step.

23. The method of claim 22, wherein said lowering step is performed by a vacuum.

24. The method of claim 22, wherein said thin film evaporator is enclosed in a pressure-controlled vessel during said lowering step.

25. The method of claim 22, further comprising maintaining the second pressure of said thin film evaporator below the saturation pressure of the working fluid during the dispensing step.

26. The method of claim 15, wherein said substance is selected from the group consisting of living cells, living embryos, or living thin tissues.

27. The method of claim 15, wherein said microstructured surface comprises micropores having a diameter between 1 and 100 microns in diameter.
